(19) United States
(12) Patent Application Publication
(10) Pub. No.: US 2017/0019622 A1
(43) Pub. Date: Jan. 19, 2017

(54) TV CONTROL METHOD AND REMOTE CONTROLLER FOR TV

(71) Applicant: LE SHI ZHI ZIN ELECTRONIC TECHNOLOGY (TIANJIN) LIMITED, Beijing (CN)

(72) Inventor: Yan YANG, Beijing (CN)

(73) Assignee: LE SHI ZHI XIN ELECTRONIC TECHNOLOGY (TIANJIN) LIMITED, Beijing (CN)

(21) Appl. No.: 15/039,408

(22) PCT Filed: Nov. 12, 2014
(86) PCT No.: PCT/CN2014/090916

§ 371 Date: May 25, 2016

(30) Foreign Application Priority Data
Nov. 29, 2013 (CN) 201310637914.4

(51) Int. Cl. H04N 5/44; H04N 21/422

(52) U.S. Cl. CPC H04N 5/4403; H04N 21/4221; H04N 2005/4412

(57) ABSTRACT

Provided are a monitoring method and device for smart homes and a smart home system, which relate to the technical field of displays and can increase the monitoring efficiency, thus increasing the man-machine interaction performance. The method may comprise: when a display device is in a standby mode, if the display device detects a data signal sent by a sending device of a smart home, triggering, by the data signal, the display device to be started, the data signal being used for characterizing access information about an accessor; and receiving and saving, by the display device, the data signal.

### TECHNICAL FIELD

The present application relates to the field of electronic information technologies, and more particularly, to a TV control method and a TV remote controller.

### BACKGROUND

At present, with the increasing of people's living standard, TVs are becoming more and more popular. Various functions of a prior TV are generally implemented by operating keys thereon. With the continuous improvement of technology, smart TVs now may be generally controlled to function through a remote controller. For example, the user can browse webpages and read news on the TV by controlling the Up, Down, Left and Right keys of the TV remote controller. However, when the user wants to read the news closer to the bottom of the website, there are often multiple news links in the middle if moving from the top to the bottom of the website, the user may need to continuously press the direction key for dozens of times and also need to pay attention to the movement of the focus for not losing the focus, which causes great inconvenience.

In the prior art, an air mouse solution is proposed to solve the problem, but the TV remote controller having the mode of air mouse has to be switched to the mode of air mouse such that the remoter controller can implement various operations by controlling the cursor movement. Thus, how to perform related operations through the cursor on the basis of not switching to the mode of air mouse has become a problem to be solved at present.

### SUMMARY

According to the embodiments of the present application, a TV control method and a TV remote controller, which can enhance the interactive ability between a terminal and a user, are provided.

In order to achieve the above purposes, the embodiments of the present application employ the following technical solutions.

According to a first aspect, a TV control method is provided. The method includes: detecting a pressure value acted on a cursor control key and a pressure inclination angle, wherein the cursor control key is preset on the TV remote controller; generating a first execution signal according to the pressure value and the pressure inclination angle; and sending the first execution signal to a TV, and responding to the first execution signal by the TV.

According to a second aspect, a computer-readable record medium recording a program configured to conduct and implement the monitoring method for a smart home is provided.

According to a third aspect, a TV remote controller is provided. The TV remote controller includes: a detection unit, a generation unit, and a sending unit; the detection unit is configured to detect a pressure value acted on a cursor control key and a pressure inclination angle, wherein the cursor control key is preset on the TV remote controller; the generation unit is configured to generate a first execution signal according to the pressure value and the pressure inclination angle detected by the detection unit; and the sending unit is configured to send the first execution signal generated by the generation unit to a TV, and respond to the first execution signal by the TV.

### BRIEF DESCRIPTION OF THE DRAWINGS

FIG. 1 is a flow chart of a method according to the embodiments of the present application;

FIG. 2 is a flow chart of another method according to the embodiments of the present application; and

FIG. 3 is a structural schematic diagram of a TV remote controller according to the embodiments of the present application.

### DETAILED DESCRIPTION

The implementation manners of the present application will be explained in details with references to the drawings and embodiments hereinafter, so that the realization process of how to solve the technical problems by using the technical means and achieve the technical effects can be sufficiently understood and implemented accordingly.

In the embodiments of the present application, a main body for implementing a monitoring method for a smart home provided by the embodiments of the present application can be a smart home monitoring device, wherein the smart home monitoring device can either be a display device, or an independent module connected to the display device. The embodiments hereinafter are only explained by taking the smart home monitoring device as a display device for example Wherein, the display device can include devices capable of receiving a data signal transmitted by a transmitting device of a smart home, such as a smart TV, a computer, a tablet, a mobile phone, or the like.

### First Embodiment

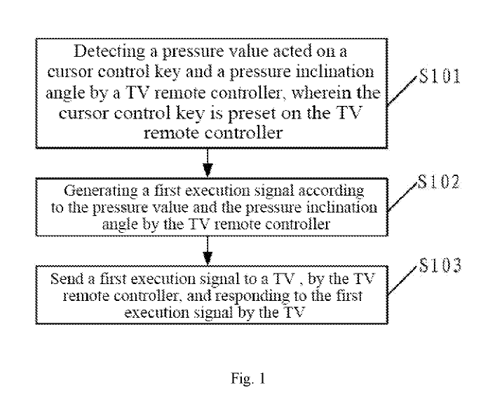

According to the embodiment of the present application, a TV control method is provided. As shown in FIG. 1, the method includes the following steps.

In step S101, a TV remote controller detects a pressure value acted on a cursor control key and a pressure inclination angle, wherein the cursor control key is preset on the TV remote controller.

Specifically, when watching TV, a user may need to execute some operations to reach a target point location or select a target. For example, the user can browse webpages and read news and the like on the TV as long as controlling the Up, Down, Left and Right keys of the TV remote controller. However, when the user wants to read the news closer to the bottom of the website, there are often multiple news links in the middle if moving from the top to the bottom of the website, the user may need to continuously press the direction key for dozens of times and further need to pay attention to the movement of the focus for not losing the focus during the operation, which causes great inconvenience to the user.

According to the TV control method of the embodiment of the present application, the user can control various operations through a cursor control key on the TV remote controller, wherein the cursor control key is preset on the TV remote controller, and a cursor is operated through the cursor control key to achieve the target point location or select the object. During the process, the TV remote controller firstly needs to detect a pressure value acted on the cursor control key by the user and a pressure inclination angle.

In step S102, the TV remote controller generates a first execution signal according to the pressure value and the pressure inclination angle.

Specifically, for the cursor control key on the TV remote controller, the pressure values and the pressure inclination angles of different keys respond to different first execution signals. Wherein, the first execution signal can specifically include: a cursor movement signal, a page rolling signal, or a selection and determination signal. The embodiments of the present application are not limited thereto.

If the pressure value is less than a first threshold, and the pressure inclination angle is larger than a second threshold, the TV remote controller, generates the cursor movement signal according to the pressure value and the pressure inclination angle; wherein, orientation vector information for cursor movement is carried in the cursor movement signal.

If the pressure value is larger than a first threshold, and the pressure inclination angle is larger than a second threshold, the TV remote controller generates the page rolling signal according to the pressure value and the pressure inclination angle; wherein, orientation vector information for cursor movement is carried in the cursor movement signal.

If the pressure value is larger than the first threshold, and the pressure inclination angle is less than the second threshold, the TV remote controller generates the selection and determination signal according to the pressure value and the pressure inclination angle.

For example, when a user intends to select a certain function on a TV screen, the cursor firstly needs to be moved to a target to be selected. If a direction key is used for operating, the direction key may need to be continuously pressed for multiple times for moving the target to be selected. While it is more convenient to select through the cursor movement, the cursor control key is lightly pushed towards a target direction to be selected, then a sensor at the bottom of the cursor control key will detect the pressure value and the pressure inclination angle of the cursor control key operated by the user, and determine the pressure value and the pressure inclination angle. If the pressure value is less than the first threshold, and the pressure inclination angle is larger than the second threshold, the TV remote controller generates a cursor movement signal according to the pressure value and the pressure inclination angle.

It should be illustrated that the first threshold and the second threshold are preset values preset in the remote controller, different first execution signals corresponding to different cursor operations may be generated by setting the magnitude relationship between the pressure value of the key and the first threshold as well as the magnitude relationship between the pressure inclination angle and the second threshold. For instance, the cursor movement signal is corresponding to the movement operation of the cursor, the page rolling signal is corresponding to the rolling operation of the page, the selection and determination signal is corresponding to the target selecting operation, or the like, which will not be illustrated one by one in the embodiments of the present application herein.

In step S103, the TV remote controller sends a first execution signal to a TV and the TV responds to the first execution signal.

Specifically, as described above, the first execution signal may include: a cursor movement signal, a page rolling signal, or a selection and determination signal. The TV remote controller sends the first execution signal to a TV, and the function operation corresponding to the first execution signal can be executed by the TV.

According to the embodiment of the present application, a TV control method is provided. The method includes: detecting a pressure value acted on a cursor control key and a pressure inclination angle by a TV remote controller, wherein the cursor control key is preset on the TV remote controller; generating a first execution signal according to the pressure value and the pressure inclination angle; and sending the first execution signal to a TV, and responding to the first execution signal by the TV. According to the TV control method of the present application, since a cursor control key and a detection unit for detecting the cursor control key are disposed in the TV remote controller, such that the TV remote controller can control the cursor displayed on the TV through the cursor control key without switching to an air-mouse mode, which enhances the interactive ability between a terminal and a user.

### Second Embodiment

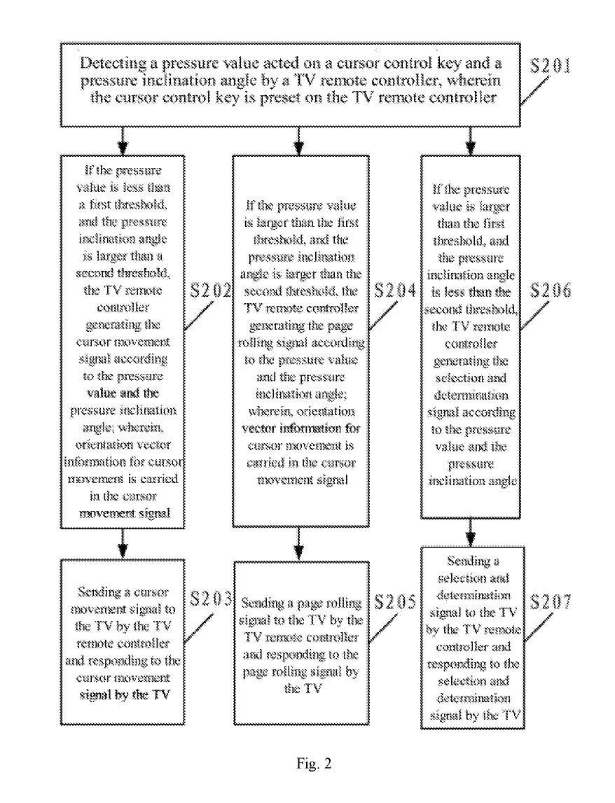

According to the embodiment of the present application, a TV control method is provided. As shown in FIG. 2, the method includes the following steps.

In step S201, the TV remote controller detects a pressure value acted on a cursor control key and a pressure inclination angle, wherein the cursor control key is preset on a TV remote controller.

Specifically, when watching TV, a user may need to execute some operations to reach a target point location or select a target. For example, the user can browse webpages and read news and the like on the TV as long as controlling the Up, Down, Left and Right keys of the TV remote controller. However, when the user wants to read the news closer to the bottom of the website, there are often multiple news links in the middle if moving from the top to the bottom of the website, the user may need to continuously press the direction key for dozens of times and further need to pay attention to the movement of the focus for not losing the focus during the operation, which causes great inconvenience to the user.

According to the TV control method of the embodiments of the present application, various operations can be controlled through a cursor control key on the TV remote controller, wherein the cursor control key is preset on the TV remote controller, and a cursor is operated through the cursor control key to achieve the target point location or select the object. During the process, the TV remote controller firstly needs to detect a pressure value acted on the cursor control key by the user and a pressure inclination angle.

If the pressure value is less than a first threshold, and the pressure inclination angle is larger than a second threshold, step S202 is executed.

If the pressure value is larger than the first threshold, and the pressure inclination angle is larger than the second threshold, step S204 is executed.

If the pressure value is larger than the first threshold, and the pressure inclination angle is less than the second threshold, step S206 is executed.

It should be illustrated that the first threshold and the second threshold are preset values preset in the remote controller, different first execution signals corresponding to different cursor operations can be generated by setting the magnitude relationship between the pressure value of the key and the first threshold as well as the magnitude relationship between the pressure inclination angle and the second threshold. For instance, the cursor movement signal is corresponding to the movement operation of the cursor, the page rolling signal is corresponding to the rolling operation of the page, the selection and determination signal is corresponding to the target selecting operation, or the like, which will not be illustrated one by one in the embodiments of the present application herein.

In step S202, if the pressure value is less than the first threshold, and the pressure inclination angle is larger than the second threshold, the TV remote controller generates a cursor movement signal according to the pressure value and the pressure inclination angle; wherein, orientation vector information for cursor movement is carried in the cursor movement signal.

Specifically, when the pressure value acted on the cursor control key by the user is less than the first threshold, and the pressure inclination angle is larger than the second threshold, the TV remote controller generates the cursor movement signal according to the pressure value and the pressure inclination angle; wherein, orientation vector information for cursor movement is carried in the cursor movement signal, and the TV can move the cursor according to the orientation vector information for cursor movement.

For example, if the preset first threshold is a, and the second threshold is b, the user lightly pushes the cursor control key towards a target direction to be selected at a certain moment, the TV remote controller detects that the pressure value acted on the cursor control key is a1<a, and the pressure inclination angle is b1>b, then the TV remote controller generates the cursor movement signal, and orientation vector information for cursor movement is carried in the cursor movement signal, i.e., the displacement information for cursor movement corresponding to the pressure value and the inclination angle.

In step S203, the TV remote controller sends a cursor movement signal to the TV and the TV responds to the cursor movement signal.

Specifically, the TV remote controller sends the cursor movement signal to the TV and a cursor movement function is executed by the TV.

In step S204, if the pressure value is larger than the first threshold, and the pressure inclination angle is larger than the second threshold, the TV remote controller generates a page rolling signal according to the pressure value and the pressure inclination angle; wherein, orientation vector information for cursor movement is carried in the cursor movement signal.

Specifically, when the pressure value acted on the cursor control key by the user is larger than the first threshold, and the pressure inclination angle is larger than the second threshold, the TV remote controller generates the page rolling signal according to the pressure value and the pressure inclination angle; wherein, orientation vector information for cursor movement is carried in the cursor movement signal, and the TV can control the rolling of the page according to the orientation vector information for cursor movement.

For example, when browsing webpages, the user may need to roll the page to rapidly find out the contents interested thereof. At this moment, the user needs to press the cursor control key, and push the cursor control key toward the rolling direction of the page target. If the preset first threshold is a, and the second threshold is b, the TV remote controller detects that the pressure value acted on the cursor control key is a2>a, and the pressure inclination angle is b2>b after the user triggers the cursor control key, then the TV remote controller generates the page rolling signal, and orientation vector information for cursor movement is carried in the page rolling signal, i.e., the rolling direction of the page corresponding to the pressure value and the inclination angle.

In step S205, the TV remote controller sends a page rolling signal to the TV and the TV responds to the page rolling signal.

Specifically, the TV remote controller sends the page rolling signal to the TV and a page rolling function is executed by the TV.

In step S206, if the pressure value is larger than the first threshold, and the pressure inclination angle is less than the second threshold, the TV remote controller generates a selection and determination signal according to the pressure value and the pressure inclination angle.

Specifically, when the pressure value acted on the cursor control key by the user is larger than the first threshold, and the pressure inclination angle is less than the second threshold, the TV remote controller generates the selection and determination signal according to the pressure value and the pressure inclination angle.

For example, if the user wants to read certain news at a certain moment, and the cursor is moved to the location of the news, then the user only needs to press the cursor control key with a force at this time. If the preset first threshold is a, and the second threshold is b, then the TV remote controller detects that the pressure value acted on the cursor control key is a3>a, and the pressure inclination angle is b3<b after the user triggers the cursor control key, then the TV remote controller generates the selection and determination signal, so that the TV executes a selection and determination function for the user to read the news after the selection and determination signal is sent to the TV.

In step S207, the TV remote controller sends the selection and determination signal to the TV and the TV responds to the selection and determination signal.

Specifically, the TV remote controller sends the selection and determination signal to the TV and the selection and determination function is executed by the TV.

According to the embodiment of the present application, a TV control method is provided. The method includes: detecting a pressure value acted on a cursor control key by a user and a pressure inclination angle by a TV remote controller, wherein the cursor control key is preset on a TV remote controller; generating a first execution signal according to the pressure value and the pressure inclination angle; and sending the first execution signal to a TV, and responding to the first execution signal by the TV. According to the TV control method of the present application, since a cursor control key and a detection unit for detecting the cursor control key are disposed in the TV remote controller, such that the TV remote controller can control the cursor displayed on the TV through the cursor control key without switching to an air-mouse mode, which enhances the interactive ability between a terminal and a user.

### Third Embodiment

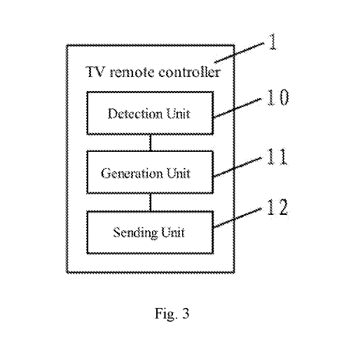

According to the embodiment of the present application a TV remote controller 1 is provided. As shown in FIG. 3, the TV remote controller 1 includes a detection unit 10, a generation unit 11, and a sending unit 12.

The detection unit 10 is configured to detect a pressure value acted on a cursor control key and a pressure inclination angle, wherein the cursor control key is preset on the TV remote controller.

The generation unit 11 is configured to generate a first execution signal according to the pressure value and the pressure inclination angle detected by the detection unit 10.

The sending unit 12 is configured to send the first execution signal generated by the generation unit 11 to the TV, and the TV responds to the first execution signal.

Wherein, the first execution signal can specifically include: a cursor movement signal, a page rolling signal, or a selection and determination signal.

In some of the embodiments, the generation unit 11 is configured to generate a first execution signal according to the pressure value and the pressure inclination angle detected by the detection unit 10, which may specifically include the followings.

If the pressure value is less than a first threshold, and the pressure inclination angle is larger than a second threshold, a cursor movement signal is generated according to the pressure value and the pressure inclination angle; wherein, orientation vector information for cursor movement is carried in the cursor movement signal.

In some of the embodiments, the generation unit 11 is configured to generate a first execution signal according to the pressure value and the pressure inclination angle detected by the detection unit 10, which may specifically include the followings.

If the pressure value is larger than a first threshold, and the pressure inclination angle is larger than a second threshold, a page rolling signal is generated according to the pressure value and the pressure inclination angle; wherein, orientation vector information for cursor movement is carried in the cursor movement signal.

In some of the embodiments, the generation unit 11 is configured to generate a first execution signal according to the pressure value and the pressure inclination angle detected by the detection unit 10, which specifically includes the followings.

If the pressure value is larger than a first threshold, and the pressure inclination angle is less than a second threshold, a selection and determination signal is generated according to the pressure value and the pressure inclination angle.

Specifically, a cursor control method conducted through the TV remote controller can be referred to the descriptions in the first embodiment or the second embodiment, which will not be further described herein.

According to the embodiment of the present applications, a TV remote controller is provided. A detection unit of the TV remote controller detects a pressure value acted on a cursor control key and a pressure inclination angle; wherein, the cursor control key is preset on a TV remote controller; a first execution signal is generated according to the pressure value and the pressure inclination angle; and the first execution signal is sent to a TV by the sending unit, and the TV responds to the first execution signal. According to the TV control method of the present application, since a cursor control key and a detection unit for detecting the cursor control key are disposed in the TV remote controller, such that the TV remote controller can control the cursor displayed on the TV through the cursor control key without switching to an air-mouse mode TV remote controller, which enhances the interactive ability between a terminal and a user.

Those skilled in the art can clearly understand that, to describe conveniently and simply, it is only illustrated by taking the division of each functional module above as an example. In practical applications, the foregoing function distribution may be accomplished by different functional modules according to requirements. That is, the interior structures of the apparatus can be divided into different functional modules so as to accomplish all or part of the functions described above. Corresponding processes in the foregoing method embodiments can be referenced for specific working processes of the device described above which will not be elaborated herein.

In several embodiments of the present application, it should be understood that the disclosed devices, and methods may be implemented in other ways. For example, the embodiments of the devices described above are only exemplary.

The units described may or may not be physically separated from each other, and the parts shown as units may be one or more physical units, that is, the parts may be located at the same place, and may also be distributed at multiple different places. A part or all of the units may be selected according to the actual requirement to achieve the objectives of the solutions in the embodiments.

In addition, functional units in the embodiments of the present application may be integrated into a processing unit, or each unit may exist singly and physically, or two or more units may be integrated in one unit. The foregoing integrated units may either be fulfilled by using a hardware form, or be fulfilled by using a software functional unit form.

If the integrated unit is implemented in the form of the software functional unit and is sold or used as an independent product, it may be stored in a readable storage medium. Based on such understandings, the technical solutions of the present application essentially, or the part contributing to the prior art, or all or a part of the technical solutions may be implemented in the form of a software product. The software product is stored in a storage medium and includes several instructions for instructing a device (which may be a single chip, a chip and so on) or a processor to execute all or a part of steps of the methods described in the embodiments of the present application. The abovementioned storage medium includes: any media that are capable of storing program codes, such as a U disk, a mobile hard disk drive, a read-only memory (ROM), a random access memory (RAM), a magnetic disk, an optical disk and so forth.

The above description is merely detailed implementation manner of the present application, but not intended to limit the protection scope of the present application. Any changes or replacements, which can be easily figured out by those skilled in the art without departing from the technical scope disclosed by the present application, shall all fall within the protection scope of the present application. Therefore, the protection scope of the present application shall be subjected to the protection scope of the claims.

1. A TV control method, comprising:
detecting a pressure value acted on a cursor control key and a pressure inclination angle, wherein the cursor control key is preset on a TV remote controller;
generating a first execution signal according to the pressure value and the pressure inclination angle; and
sending the first execution signal to a TV, and responding to the first execution signal by the TV.

2. The method according to claim 1, wherein, the first execution signal comprises:
a cursor movement signal, a page rolling signal, or a selection and determination signal.

3. The method according to claim 2, wherein, generating the first execution signal according to the pressure value and the pressure inclination angle comprises:
if the pressure value being less than a first threshold, and the pressure inclination angle being larger than a second threshold, generating the cursor movement signal according to the pressure value and the pressure inclination angle; wherein, orientation vector information for cursor movement is carried in the cursor movement signal.

4. The method according to claim 2, wherein, generating the first execution signal according to the pressure value and the pressure inclination angle comprises:
if the pressure value being larger than a first threshold, and the pressure inclination angle being larger than a second threshold, generating the page rolling signal according to the pressure value and the pressure inclination angle; wherein, orientation vector information for cursor movement is carried in the cursor movement signal.

5. The method according to claim 2, wherein, generating the first execution signal according to the pressure value and the pressure inclination angle comprises:
if the pressure value being larger than a first threshold, and the pressure inclination angle being less than a second threshold, generating the selection and determination signal according to the pressure value and the pressure inclination angle.

6. A computer-readable record medium recording a program configured to conduct the TV control method according to claim 1.

7. A TV remote controller, comprising a detection unit, a generation unit, and a sending unit;
the detection unit being configured to detect a pressure value acted on a cursor control key and a pressure inclination angle, wherein the cursor control key is preset on the TV remote controller;
the generation unit being configured to generate a first execution signal according to the pressure value and the pressure inclination angle detected by the detection unit; and
the sending unit being configured to send the first execution signal generated by the generation unit to a TV, and respond to the first execution signal by the TV.

8. The TV remote controller according to claim 7, wherein, the first execution signal comprises:
a cursor movement signal, a page rolling signal, or a selection and determination signal.

9. The TV remote controller according to claim 8, wherein, the generation unit being configured to generate the first execution signal according to the pressure value and the pressure inclination angle detected by the detection unit, comprises:
if the pressure value being less than a first threshold, and the pressure inclination angle being larger than a second threshold, generating the cursor movement signal according to the pressure value and the pressure inclination angle; wherein, orientation vector information for cursor movement is carried in the cursor movement signal.

10. The TV remote controller according to claim 8, wherein, the generation unit being configured to generate the first execution signal according to the pressure value and the pressure inclination angle detected by the detection unit, comprises:
if the pressure value being larger than a first threshold, and the pressure inclination angle being larger than a second threshold, generating the page rolling signal according to the pressure value and the pressure inclination angle; wherein, orientation vector information for cursor movement is carried in the cursor movement signal.

11. The TV remote controller according to claim 8, wherein the generation unit being configured to generate the first execution signal according to the pressure value and the pressure inclination angle detected by the detection unit, comprises:
If the pressure value being larger than a first threshold, and the pressure inclination angle being less than a second threshold, generating the selection and determination signal according to the pressure value and the pressure inclination angle.
